(19) United States
(12) Patent Application Publication
(10) Pub. No.: US 2001/0010561 A1
(43) Pub. Date: Aug. 2, 2001

(54) Image sensing apparatus and method

(76) Inventor: Norio Nagai, Asaka-shi (JP)

Correspondence Address: BIRCH STEWART KOLASCH & BIRCH, PO BOX 747, FALLS CHURCH, VA, 22040-0747, US

(21) Appl. No.: 09/766,577

(22) Filed: Jan. 23, 2001

(30) Foreign Application Priority Data
Jan. 24, 2000 (JP) 2000-13609

(51) Int. Cl. H04N 5/222; H04N 5/76

(52) U.S. Cl. 348/371; 348/240; 348/333.03; 348/232

(57) ABSTRACT

The image of a subject obtained by photography is displayed on a display unit provided on a digital still camera. The user designates a zoom area and magnification on the displayed image of the subject. The illumination angle of a strobe light-emission unit is controlled in such a manner that a position on the subject that corresponds to the center of the designated zoom area is illuminated with strobe light. The zoom image thus obtained is brightened in emphasized fashion by the strobe light-emission unit.

### BACKGROUND OF THE INVENTION

1. Field of the Invention

This invention relates to an image sensing apparatus having an image sensing device for sensing the image of a subject and outputting image data representing the image of the subject, and a recording control unit for recording the image data, which has been output from the image sensing device, on a recording medium. The invention further relates to an image sensing method associated with this apparatus.

2. Description of the Related Art

Advances in technology have made it possible to raise the number of pixels in CCDs employed in an image sensing apparatus such as a digital still camera. An increase in the number of pixels used in a CCD raises the resolution of images obtained by imaging employing the CCD. The higher resolution of such images makes it possible even for images enlarged by electronic zooming to withstand close scrutiny.

However, an image that has undergone electronic zooming is not necessarily easy to see when it is displayed on a display screen.

### DISCLOSURE OF THE INVENTION

Accordingly, an object of the present invention is make it easier to view even a displayed image that has undergone electronic zooming.

According to the present invention, the foregoing object is attained by providing an image sensing apparatus comprising: an image sensing device for sensing the image of a subject and outputting image data representing the image of the subject; a display control unit for controlling a display unit in such a manner that the image of the subject represented by the image data output from the image sensing device will be displayed on a display screen; a designating unit for designating an electronic zoom area in the image of the subject displayed on the display screen; a light-emission control unit for controlling a strobe light-emission device in such a manner that a part of the subject that corresponds to an image within the electronic zoom area is illuminated with strobe light; and a recording control unit for recording, on a recording medium, image data output from the image sensing device and data indicating position of the electronic zoom area or image data representing the image within the electronic zoom area.

The present invention provides also a method suited to the above-described apparatus. Specifically, the method comprises the steps of: sensing the image of a subject and outputting image data representing the image of the subject; displaying the image of the subject represented by the obtained image data on a display screen of a display unit; illuminating, with strobe light, a part of the subject that corresponds to an image within an electronic zoom area designated in the image of the subject displayed on the display screen; and recording, on a recording medium, image data obtained by image sensing and data indicating position of the electronic zoom area or image data representing the image within the electronic zoom area.

In accordance with the present invention, the image of a subject obtained by image sensing is displayed on the display screen of a display unit. An electronic zoom area is designated in the image of the subject displayed on the display screen. A strobe light-emission unit is controlled so as to illuminate the portion of the subject that corresponds to the image within the designated electronic zoom area. Image data representing the image of the subject over the entire range of photography and data indicating the position of the electronic zoom area or image data representing the part of the image of the subject that lies within the electronic zoom area is recorded on a recording medium.

In accordance with the present invention, the image within the electronic zoom area becomes brighter because the angle of illumination of the strobe light-emission unit is controlled in such a manner that the portion of the subject corresponding to the image within the electronic zoom area is illuminated with strobe light. As a result, even an electronically zoomed image becomes comparatively easier to see.

Though an arrangement may be adopted in which control is performed so as to make the optic axis of the strobe light-emission unit coincide with the center of the electronic zoom area, the optic axis need not necessarily coincide with the center position. It will suffice if the strobe light-emission unit is caused to emit strobe light which emphasizing the portion of the subject that corresponds to the electronic zoom area.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical construction of a digital still camera;

FIG. 2a illustrates an ordinary image and FIG. 2b a zoomed image;

FIG. 3 illustrates an example of the data structure of a memory card;

FIG. 4 is a flowchart illustrating processing executed when sensing an image; and

FIG. 5 is a flowchart illustrating processing executed when an image is reproduced.

### DESCRIPTION OF THE PREFERRED EMBODIMENT

A preferred embodiment of the present invention will now be described in detail.

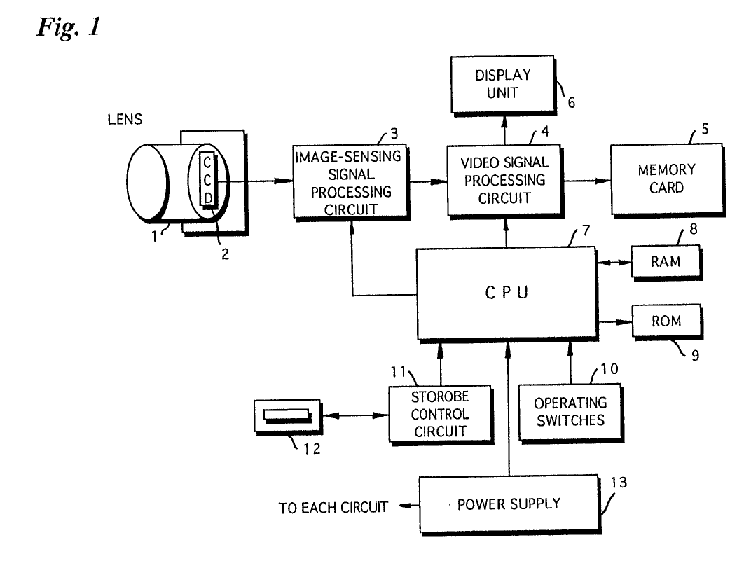

FIG. 1 is a block diagram illustrating the electrical construction of a digital still camera according to the present invention.

The overall operation of the digital still camera is controlled by a CPU 7.

The digital still camera includes a group of operating switches 10 from which a signal indicative of the operation thereof is input to the CPU 7. The operating switches 10 include a shutter-release button, a switch for switching between display of an ordinary image (a full image, described later) and display of an electronically zoomed image, a switch for designating zoom magnification, a recording confirmation switch, a switch for verifying the illuminating angle of a strobe flash, a playback switch, and a zoom changeover switch for changing over between manual-zoom playback and auto-zoom playback.

The digital still camera is capable of strobe (flash) photography. To this end, the digital still camera includes a strobe light-emission unit 12 and a strobe control circuit 11. The strobe light-emission unit 12 is controlled by the strobe control circuit 11 is such a manner that strobe light is emitted in a desired direction (i.e., at a desired angle).

The digital still camera further includes a power supply 13, which supplies operating power to each circuit of the digital still camera.

The CPU 7 of the digital still camera is externally provided with a working RAM 8 that temporarily stores values for adjusting f-stop value and color balance, as well as other data, and a ROM 9 for storing an operating program and other prescribed data.

The image of a subject is formed on the photoreceptor surface of a CCD 2 by an imaging lens 1. A video signal representing the image of the subject is output from the CCD 2 and input to a signal processing circuit 3 for image sensing. The image-sensing signal processing circuit 3 executes predetermined signal processing such as a gamma correction and color balance adjustment. The video signal output from the image-sensing signal processing circuit 3 is input to a signal processing circuit 4 for video.

The video signal processing circuit 4 converts the analog video signal to digital image data and applies this digital image data to a display unit 6. The CCD 2 is of the type having a large number of pixels. The video signal processing circuit 4 usually downsamples pixels in such a manner that the number of pixels constituting one frame of an image will become the number of pixels of an image displayed on the display unit 6. The image data downsampled pixels is applied the display unit 6. The digital still camera further has an electronic zoom function. When a zoom area has been designated as by a zoom-area designating switch, as will be described later, pixel downsampling is carried out in such a manner that part of an image within the designated area will become an image (a zoomed image) displayed on the display unit 6. More specifically, a zoomed image is produced by arranging it so that the downsampling ratio of pixel downsampling is reduced. The zoomed image is displayed on the display screen of the display unit 6. The video signal processing circuit 4 further has functions for data compression and for executing processing to generate a luminance signal and color difference signal.

If the shutter-release button included among the operating switches 10 is pressed, image data representing the image of the subject is compressed by the video signal processing circuit 4 as mentioned earlier. The image data thus compressed is applied to a memory card 5.

The digital still camera according to this embodiment possesses a playback function as well.

If the playback switch included among the operating switches 10 is set, compressed image data is read out of the memory card 5. The image data that has been read out is applied to the video signal processing circuit 4, which proceeds to expand the image data. The expanded image data is applied to the display unit 6, whereby the image representing the image data that has been recorded on the memory card 5 is displayed on the display screen of the display unit 6.

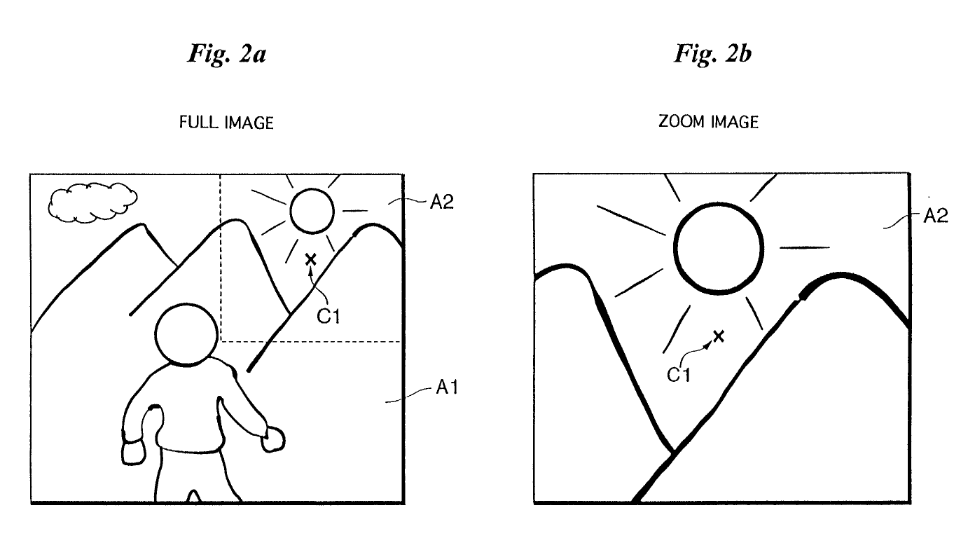

FIG. 2a illustrates an example of an ordinary image displayed on the display screen of the display unit 6, and FIG. 2b illustrates an example of a zoomed image displayed on the display screen of the display unit 6.

When the electronic zoom display has not been set by the zoom changeover switch included among the operating switches 10, the full image photographed by the CCD 2 is displayed on the display screen of the display unit 6, as mentioned above. The full image is obtained by downsampling one frame of image data, which has been output by the CCD 2, and displaying the resultant image on the display screen of the display unit 6.

An arrow C indicating the center of an electronic zoom area A2 is displayed on the full image. (Though the electronic zoom area A2 is displayed on the full image in FIG. 2a, the area A2 need not necessarily be displayed.)

If the electronic zoom display is set by the zoom changeover switch included among the operating switches 10, the image within the zoom area A2 is displayed over the entire display screen of display unit 6, as mentioned above. (The displayed image is a zoom image.) For example, by changing the downsampling ratio as mentioned above, or by applying only image data representing the image within the zoom area A2 to the display unit 6 without downsampling processing of image data representing the full image obtained by image sensing, a zoom image made larger than the full image is obtained. The arrow C1 indicating the center of the area A2 is displayed on the full image as well.

It goes without saying that the arrow C1 indicating the center of the zoom area A2 need not necessarily be displayed on the full image or zoom image.

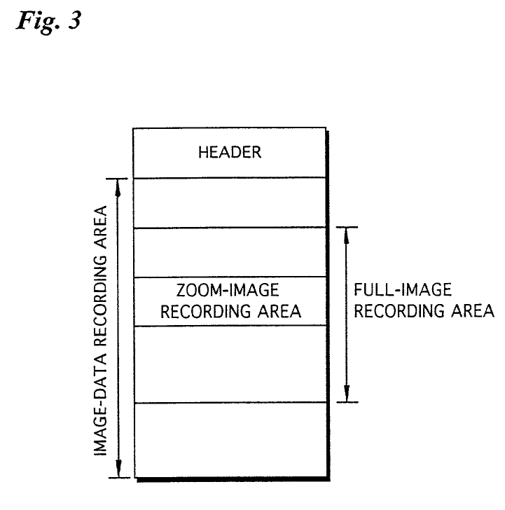

FIG. 3 illustrates the data structure of the memory card 5.

The memory card 5 includes a header and an image-data recording area.

Image data representing the full image that can be photographed by the CCD 2 is recorded in the image-data recording area of the memory card 5. One frame of image data representing the full image that includes the zoom area A2 is recorded in the image-data recording area of the memory card 5 even in a case where the shutter-release button is pressed when the zoom image is being displayed on the display screen of the display unit 6 by the electronic zoom function. Of the one frame of image data representing the full image, data which specifies the image data within the zoom area A2 is recorded in the header. It goes without saying that an arrangement may be adopted in which image data representing only the image within the zoom area A2 is recorded in the image-data recording area of the memory card 5 separately of the one frame of image data that includes the zoom area A2.

Management information for managing the memory card 5 is recorded in the header in addition to data which specifies the image data within the zoom area A2.

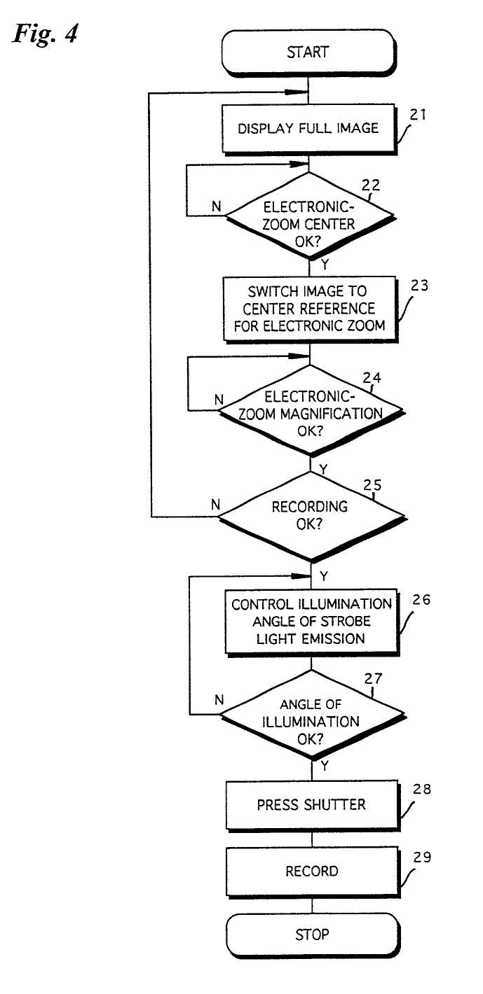

FIG. 4 is a flowchart illustrating processing for recording image data using the digital still camera.

When the power supply of the digital still camera is turned on to establish the picture-taking mode, the image of the subject is sensed by the CCD 2. When this takes place, the full image is displayed on the display screen of the display unit 6, as set forth above (step 21). The user checks the position of the arrow C1 being displayed on the full image. If the zoom area A2 having the position of arrow C1 at its center is to be zoomed and displayed (“YES” at step 22), the user operates the zoom changeover switch included among the operating switches 10 (step 23).

If the zoom changeover switch is operated, the image within the zoom area A2 having the position of arrow C1 at its center is displayed over the entire display screen of the display unit 6. The zoom magnification switch included among the operating switches 10 is pressed by the user to change the zoom magnification of the zoom image (step 24). When the zoom image zoomed with regard to the desired zoom area A2 and having the desired zoom magnification is displayed on the display screen of the display unit 6 (“YES” at step 24), the recording verification switch is set by the user (step 25).

When this is done, the illumination angle of the strobe light-emission unit 12 is controlled by the strobe control circuit 11 in such a manner that strobe light from the strobe light-emission unit 12 will illuminate precisely the position of the subject that corresponds to the center point C1 in the zoom area A2 that has been set (Step 26). When control of the illumination angle of strobe light-emission unit 12 is completed, text notifying the user of completion of illumination-angle control appears on the display screen or the display unit 6. Upon observing this text and verifying that control of the illumination angle has ended (Step 27), the user presses the verification switch included among the operating switches 10.

If the user then presses the shutter-release button (step 28), the image of the subject is sensed and image data representing the full image capable of being photographed by the CCD 2 is recorded on the memory card 5 (step 29). It goes without saying that data (data indicating zoom magnification, image data, etc.) for specifying image data representing the image in the electronic-zoom area A2 contained in the full image also is recorded on the memory card 5, as set forth above.

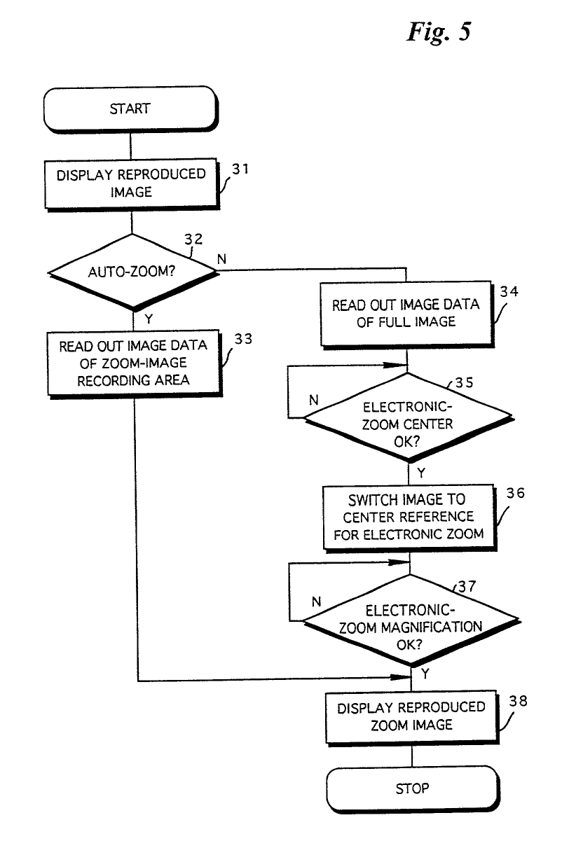

FIG. 5 is a flowchart illustrating playback processing executed in the digital still camera.

If the playback switch included among the operating switches 10 is pressed, the playback mode is established. In accordance with the playback mode, compressed image data is read out of the memory card 5, which has been inserted into the digital still camera, and the read image data is applied to the video signal processing circuit 4. The latter expands the image data, as mentioned above. The expanded image data is applied to the display unit 6, which proceeds to display the reproduced image on its display screen (step 31).

Next, the user sets either auto-zoom playback or manual-zoom playback by pressing a zoom playback button.

If auto-zoom playback is selected (“YES” at step 32), data for specifying the image data within the electronic zoom area recorded in the header of the memory card 5 is read out. On the basis of the specifying data, image data representing the image within the zoom area is read out from among one frame of image data of the full image, which is photographed by the CCD 2, that has been recorded in the image-data recording area of the memory card 5 (step 33). The video signal processing circuit 4 executes zoom processing (a downsampling ratio conforming to the zoom magnification is decided and the downsampling processing is executed based upon the decided downsampling ratio) in such a manner that the image data that has been read out will take on the zoom magnification that prevailed at the time of photography. The image data that has undergone zoom processing is applied to the display unit 6, whereby a zoom image (see FIG. 2b) having an angle of view and a zoom magnification identical with those of the image zoom-processed at the time of photography is displayed on the display screen of the display unit 6 (step 38).

If manual-zoom playback has been set (“NO” at step 32), compressed image data representing the full image is read out of the memory card 5 (step 34). The compressed image data that has been read out is expanded by the video signal processing circuit 4 and the expanded image data is applied to the display unit 6. As a result, the full image (see FIG. 2a) that has been sensed by the CCD 2 is displayed on the display screen of the display unit 6.

The arrow C1 indicating the center of the electronic zoom area is displayed on the image in a manner similar to that at the time of photography. The user moves the center of the electronic zoom area. When the center of the electronic zoom area is decided (“YES” at step 35), the image-display changeover switch is operated by the user (step 36) and the image displayed on the display screen of the display unit 6 changes over from the full image to the enlarged zoom image (step 36).

If zoom magnification is set by the user (“YES” at step 37), the zoom image having the set zoom magnification is displayed on the display screen of the display unit 6 (step 38). At the time of playback also it goes without saying that pixel downsampling processing is executed by the video signal processing circuit 4 when an ordinary image is displayed and that pixel downsampling processing is halted or the downsampling ratio is reduced when a zoom image is displayed.

In the embodiment set forth above, a zoom image is obtained by performing pixel downsampling when a full image is displayed and by forgoing pixel downsampling or performing downsampling so as to reduce the downsampling ratio when a zoom image is displayed. However, it is permissible to adopt an arrangement in which a zoom image is obtained by not executing pixel downsampling when a full image is displayed and by performing pixel interpolation when a zoom image is displayed.

It goes without saying that although the circuits described above are indicated as being implemented by hardware, these circuits can be implemented by software.

As many apparently widely different embodiments of the present invention can be made without departing from the spirit and scope thereof, it is to be understood that the invention is not limited to the specific embodiments thereof except as defined in the appended claims.

What is claimed is:

1. An image sensing apparatus comprising:
an image sensing device for sensing the image of a subject and outputting image data representing the image of the subject;
a display control unit for controlling a display unit in such a manner that the image of the subject represented by the image data output from said image sensing device will be displayed on a display screen;
a designating unit for designating an electronic zoom area in the image of the subject displayed on the display screen;
a light-emission control unit for controlling a strobe light-emission device in such a manner that a part of the subject that corresponds to an image within the electronic zoom area is illuminated with strobe light; and
a recording control unit for recording, on a recording medium, image data output from said image sensing device and data indicating position of the electronic zoom area or image data representing the image within the electronic zoom area.

2. An image sensing method comprising the steps of:
sensing the image of a subject and outputting image data representing the image of the subject;
displaying the image of the subject represented by the obtained image data on a display screen of a display unit;
illuminating, with strobe light, a part of the subject that corresponds to an image within an electronic zoom area designated in the image of the subject displayed on the display screen; and
recording, on a recording medium, image data obtained by image sensing and data indicating position of the electronic zoom area or image data representing the image within the electronic zoom area.
